(19) United States
(12) Patent Application Publication
(10) Pub. No.: US 2020/0165497 A1
(43) Pub. Date: May 28, 2020

(54) DOUBLE-SIDED ADHESIVE TAPE OR SHEET AND PRODUCTION METHOD THEREFOR

(71) Applicant: OJI HOLDINGS CORPORATION, Chuo-ku, Tokyo (JP)

(72) Inventors: Kazuo IKEDA, Chuo-ku, Tokyo (JP); Masahiro NAKATA, Chuo-ku, Tokyo (JP); Minoru INOUE, Chuo-ku, Tokyo (JP); Takamichi YAMAGUCHI, Chuo-ku, Tokyo (JP); Tohru MURAI, Chuo-ku, Tokyo (JP); Kenji YANAGISAWA, Chuo-ku, Tokyo (JP)

(21) Appl. No.: 16/632,099

(22) PCT Filed: Jul. 13, 2018
(86) PCT No.: PCT/JP2018/026528

§ 371 Date: Jan. 17, 2020

(30) Foreign Application Priority Data
Jul. 18, 2017 (JP) 2017-139531

(51) Int. Cl. C09J 133/08; C09J 7/24; C09J 133/10; C09J 7/40

(52) U.S. Cl. CPC C09J 133/08; C09J 7/241; C08K 5/101; C09J 7/40; C09J 2205/102; C09J 133/10

(57) ABSTRACT

Provided is a double-sided adhesive tape or sheet which is light-weight and has excellent strength and insulating properties even when the thickness of the tape or sheet is small. This double-sided adhesive tape or sheet comprises a laminate including a support and two adhesive agent layers formed on opposite surfaces of the support, wherein the support contains a polypropylene resin, the adhesive agent layers contain an acrylic polymer, the laminate has a total thickness (Ds) of 4-15 μm, the value of the ratio Dp/Ds of the thickness (Dp) of the support to the total thickness (Ds) of the laminate is 0.15-0.6, and the laminate has a density of 0.90-1.10 g/cm³.

### TECHNICAL FIELD

The present invention relates to a double-sided adhesive tape or sheet and a production method therefor.

### BACKGROUND ART

Conventionally, there have been proposed a double-sided adhesive tape or a double-sided adhesive sheet (referred to as “double-sided adhesive tape or sheet” in this specification) which is used for assembling various electronic devices such as mobile phones, and is widely used as a material for fixing various electronic components. In addition, in secondary batteries such as a lead storage battery, a nickel cadmium battery, a nickel hydrogen battery, and a lithium ion battery, an adhesive tape or sheet is used for the purpose of exhibiting functions such as core fixing, insulating properties of an electrode outlet, terminal stopping, or insulating spacer.

In recent years, in particular, as represented by electronic devices such as mobile devices, functions of various electronic devices have been diversified, and demands for miniaturization (thinning) and weight reduction have increased more rapidly. Therefore, the double-sided adhesive tape or sheet is also required to be extremely thin and light-weight. From this point of view, various double-sided adhesive tapes and the like have been proposed, and examples of the double-sided adhesive tapes include a thin double-sided adhesive tape or sheet which has a laminated structure in which an adhesive agent layer is formed on both surfaces of a polyethylene terephthalate film support (see Patent Document 1). On the other hand, Patent Document 2 discloses a double-sided adhesive tape using a polypropylene film as a support.

### PRIOR ART DOCUMENTS

### Patent Documents

Patent Document 1: Japanese Patent Laid-Open Publication No. 2005-105212

Patent Document 2: Japanese Patent No. 3473929

### SUMMARY OF THE INVENTION

### Problems to be Solved by the Invention

However, the polyethylene terephthalate film support described in Patent Document 1 has a higher density than that of a polypropylene support, and there is a problem that the polyethylene terephthalate film support becomes heavier than the polypropylene support having the same thickness, for example, even if a thin support is used. In addition, Patent Document 2 does not disclose the problem that when a polypropylene film having a thickness of 30 to 300 μm which is used as a support is thin, performance such as strength and insulating properties (dielectric breakdown characteristics) is likely to deteriorate and a solution of the problem. The present inventors have found that there is room for improvement in the conventional double-sided adhesive tape or sheet from such a viewpoint.

The present invention has been made in view of the above situations, and an object of the present invention is to provide a double-sided adhesive tape or sheet which is light-weight and has excellent strength and insulating properties even when a thickness of the double-sided adhesive tape or sheet is thin.

### Means for Solving the Problem

As a result of intensive studies to achieve the above object, the present inventors have found that the object can be achieved by adjusting the thickness of the polypropylene support and the total thickness of the support and the acrylic adhesive agent layer to an appropriate range, and have completed the present invention. That is, the present invention includes, for example, the inventions described in the following items.

Item 1. A double-sided adhesive tape or sheet including: a laminate including a support and two adhesive agent layers formed on both surfaces of the support,

in which the support contains a polypropylene resin,

the adhesive agent layer contains an acrylic polymer,

a total thickness (Ds) of the laminate is 4 to 15 μm,

a ratio Dp/Ds of a thickness (Dp) of the support to the total thickness (Ds) of the laminate is 0.15 to 0.6, and

a density of the laminate is 0.90 to 1.10 g/cm³.

Item 2. The double-sided adhesive tape or sheet of Item 1, in which a value of the ratio Dp/Ds is 0.18 to 0.35, and

the density of the laminate is 0.90 to 1.07 g/cm³.

Item 3. The double-sided adhesive tape or sheet according to Item 1 or 2, in which the thickness (Dp) of the support is 1.5 to 6 μm.

Item 4. The double-sided adhesive tape or sheet according to any one of Items 1 to 3, in which the support is a biaxially oriented polypropylene film having a density of 0.90 to 0.94 g/cm³.

Item 5. The double-sided adhesive tape or sheet according to any one of Items 1 to 4, in which the support contains 80 to 100% by mass of isotactic homopolypropylene having a mesopentad fraction of 90 to 99.5% with respect to a total mass of the support.

Item 6. The double-sided adhesive tape or sheet according to any one of Items 1 to 5, in which the adhesive agent layer contains as a main component an acrylic copolymer containing a (meth)acrylic ester unit (a1).

Item 7. The double-sided adhesive tape or sheet according to any one of Items 1 to 6, in which the adhesive agent layer is a layer in which an acrylic adhesive composition is solidified, and

the acrylic adhesive composition contains as a main component a crosslinkable acrylic copolymer (A) containing a noncrosslinkable(meth)acrylic ester unit (a1) and an acrylic monomer unit (a2) having a crosslinkable functional group.

Item 8. The double-sided adhesive tape or sheet according to Item 7, in which the noncrosslinkable(meth)acrylic ester unit (a1) is two types of an n-butyl acrylate monomer unit and a methyl acrylate monomer unit, the acrylic monomer unit (a2) having the crosslinkable functional group is an acrylic acid monomer unit,

in the acrylic adhesive composition, the n-butyl acrylate monomer unit is 45 to 84% by mass, the methyl acrylate monomer unit is 15 to 54% by mass, and the acrylic acid monomer unit is 1 to 10% by mass.

Item 9. The double-sided adhesive tape or sheet according to any one of Items 1 to 8, in which the adhesive agent layer is a layer in which an acrylic adhesive composition is solidified, and

the acrylic adhesive composition contains a crosslinking agent (B).

Item 10. The double-sided adhesive tape or sheet according to item 9, in which the crosslinking agent (B) is at least one selected from the group consisting of N,N,N′,N′-tetraglycidyl-m-xylenediamine and 1,3-bis(N,N-diglycidylaminomethyl)cyclohexane.

Item 11. A laminated tape or sheet including: the double-sided adhesive tape or sheet according to any one of items 1 to 10; and a separator,

in which the separator is formed on an outer side of the adhesive agent layer on at least one side of the double-sided adhesive tape or sheet.

Item 12. The laminated tape or sheet according to Item 11, in which the separator is formed on the outer sides of each of the adhesive agent layers on both sides.

Item 13. A production method for a double-sided adhesive tape or sheet including a laminate including a support and two adhesive agent layers formed on both surfaces of the support, the production method including:

forming the support with a raw material containing a polypropylene resin; and

forming the adhesive agent layer with an acrylic adhesive composition containing an acrylic adhesive,

in which a total thickness (Ds) of the laminate is 4 to 15 μm,

a ratio Dp/Ds of a thickness (Dp) of the support and the total thickness (Ds) of the laminate is 0.15 to 0.6.

Item 14. The production method according to item 13, further including:

forming the adhesive agent layer on a separator:

producing a laminated tape or sheet by bonding a surface on which the adhesive agent layer of the separator is formed, to one surface or both surfaces of the support; and

peeling off the separator from the laminated tape or sheet.

Item 15. The production method according to item 13 or 14, in which the raw material containing the polypropylene resin contains 80 to 100% by mass of isotactic homopolypropylene having a mesopentad fraction of 90 to 99.5% with respect to a total mass of the raw material.

Item 16. The production method according to any one of items 13 to 15, further including: forming the adhesive agent layer on the separator; and

bonding the surface on which the adhesive agent layer of the separator is formed, to the one surface or both surfaces of the support.

### Advantages of the Invention

The double-sided adhesive tape or sheet according to the present invention is light-weight, and is excellent in strength, adhesiveness and insulating properties even when the thickness of the double-sided adhesive tape or sheet is thin. Therefore, the double-sided adhesive tape or sheet according to the present invention can be suitably used, for example, for electronic devices such as mobile devices that are required for downsizing (thinning) or weight reduction.

### BRIEF DESCRIPTION OF THE DRAWINGS

FIG. 1 is a cross-sectional view showing an example of an embodiment of a double-sided adhesive tape or sheet of the present invention.

FIG. 2 is a cross-sectional view showing an example of an embodiment of a laminated tape or sheet of the present invention.

### EMBODIMENTS OF THE INVENTION

Hereinafter, embodiments of the present invention will be described in detail. Note that in this specification, the expressions “containing” and “including” include the concepts of “containing”, “including”, “substantially consisting of”, and “consisting only of”.

1. Double-Sided Adhesive Tape or Sheet

The present invention relates to a double-sided adhesive tape or sheet including a laminate including a support and two adhesive agent layers formed on both surfaces of the support, in which

the support contains a polypropylene resin,

the adhesive agent layer contains an acrylic adhesive composition,

in which a total thickness (Ds) of the laminate is 4 to 15 μm,

a ratio Dp/Ds of a thickness (Dp) of the support and the total thickness (Ds) of the laminate is 0.15 to 0.6, and

a density of the laminate is 0.90 to 1.10 g/cm³.

Note that in the present specification, the double-sided adhesive tape or sheet means a double-sided adhesive tape or a double-sided adhesive sheet.

The double-sided adhesive tape or sheet is light-weight, and is excellent in strength, adhesiveness, and insulating properties even when the thickness of the double-sided adhesive tape or sheet is thin. Moreover, the double-sided adhesive tape or sheet employs a specific combination of a support containing a polypropylene resin and two adhesive agent layers containing an acrylic polymer formed on both surfaces of the support, and as a result, can be bonded so as to bury minute irregularities by suppressing voids (called gaps or air) from being formed even if the minute irregularities on a nano-order level are in the adherend when the double-sided adhesive tape or sheet is bonded to the adherend (that is, the double-sided adhesive tape or sheet according to the present invention is excellent in irregularities followability).

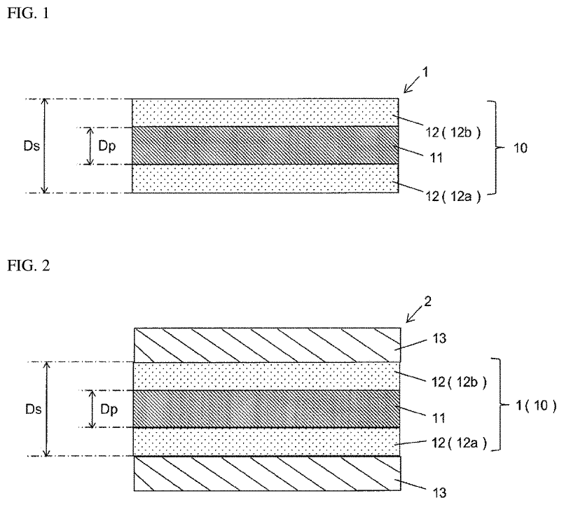

FIG. 1 is an example of an embodiment of a double-sided tape or sheet of the present invention, and shows a cross-sectional view of the double-sided adhesive tape or sheet.

A double-sided adhesive tape or sheet 1 in the form of FIG. 1 is formed by a laminate 10 that includes a support 11 and two adhesive agent layers 12 formed on both surfaces of the support 11. In FIG. 1, the two adhesive agent layers 12 are a first adhesive agent layer 12a and a second adhesive agent layer 12b, respectively. In FIG. 1, Ds represents a total thickness of the laminate 10, and Dp represents a thickness of the support 11.

Hereinafter, the configuration of the double-sided adhesive tape or sheet of the present invention will be described in detail.

(Support)

The support is a constituent member for supporting the adhesive agent layer, and is formed in a long tape shape or a sheet shape.

The support includes a polypropylene resin.

A type of the polypropylene resin is not particularly limited. For example, the polypropylene resin includes propylene homopolymers such as isotactic polypropylene and syndiotactic polypropylene; copolymer or terpolymer of propylene and α-olefins such as ethylene or butene; long-chain branched polypropylene; ultrahigh molecular weight polypropylene, and the like.

The polypropylene resin contained in the support may be alone, or in combination of two or more.

A main component of the support is preferably the polypropylene resin. Note that in the present invention and the present specification, the “main component” is contained at 50% by mass or more, preferably 70% by mass or more, more preferably 90% by mass or more, still more preferably 95% by mass or more, and particularly preferably 99% by mass or more in terms of solid content in a targeted layer or composition (herein, support).

The support may be composed only of the polypropylene resin, and may contain materials other than the polypropylene resin as long as the effects of the present invention are not hindered. For example, the support may contain additives such as an antioxidant, a chlorine absorbent, an ultraviolet absorbent, a lubricant, a plasticizer, a flame retardant, and a colorant in addition to various resins other than the polypropylene resin. Examples of resins other than the polypropylene resin include polyolefin-based resins or cyclic polyolefin-based resins, polyamide-based resins, polyimide-based resins, acrylic resins, polystyrene-based resins, polycarbonate-based resins, and the like other than polypropylene. These resins may be contained in the support alone or in combination of two or more.

The support preferably contains 80 to 100% by mass of isotactic homopolypropylene having a mesopentad fraction of 90 to 99.5% with respect to the total mass of the support. The mesopentad fraction is preferably 90% or more to improve the strength and insulating properties (dielectric breakdown voltage) of the double-sided adhesive tape or sheet. The mesopentad fraction is more preferably 91% or more, still more preferably 92% or more, and particularly preferably 93% or more. By setting the mesopentad fraction to be 99.5% or less, it becomes easy to reduce the density of the support and to suppress embrittlement during low temperature use. The mesopentad fraction is more preferably 99% or less, still more preferably 98.5% or less, and particularly preferably 98% or less. When the isotactic homopolypropylene having the mesopentad fraction in the above range is contained in an amount of 80 to 100% by mass, more preferably 90% or more, and still more preferably 95% or more, the strength and insulating properties are further improved.

The mesopentad fraction ([mmmm]) is an index of stereoregularity that can be obtained by high temperature nuclear magnetic resonance (NMR) measurement. Specifically, for example, the measurement can be performed using a high temperature Fourier transform nuclear magnetic resonance apparatus (high temperature FT-NMR). JNM-ECP500, manufactured by JEOL Ltd. The observation nucleus is ¹³C (125 MHz), the measurement temperature is 135° C., and as a solvent that dissolves the polypropylene resin, ortho-dichlorobenzene (a mixed solvent of ODCB:ODCB and deuterated ODCB (mixing mass ratio=4/1)) can be used. The measurement method by high-temperature NMR can be performed, for example, by referring to the method described in “Japan Analytical Chemistry/Polymer Analysis Research Council, New Edition Polymer Analysis Handbook, Kinokuniya, 1995, p. 610”.

The measurement mode can be single pulse proton broadband decoupling, a pulse width can be 9.1 μsec (45° pulse), a pulse interval can be 5.5 sec. the number of times of integration can be 4500 times, and a shift reference can be CH₃ (mmmm)=21.7 ppm.

A pentad fraction representing the degree of stereoregularity is calculated by a percentage based on an integrated value of the intensity of each signal due to a combination of pentad (mmmm, mrrm, and the like) of “meso (m)” arranged in the same direction and “rasemo (r)” arranged in different directions. Each signal derived from mmmm, mrrm, and the like can be assigned with reference to, for example, “T. Hayashi et al., Polymer, Vol. 29, p. 138 (1988)”, and the like.

A melt mass flow rate (MFR) of the polypropylene resin is preferably 2 to 7 g/10 minutes, more preferably 2.5 to 6.5 g/10 minutes, and further preferably 3 to 6 g/10 minutes. In this case, since the thickness of the support formed is excellent in uniformity (thickness deviation), the thickness of each layer of the double-sided adhesive tape or sheet is easily adjusted, and the stability of quality is excellent. Here, the melt mass flow rate (MFR) is a measured value at 230° C. and a load of 21.18 N, and can be measured according to JIS K 7210-1999.

A weight average molecular weight (Mw) of the polypropylene resin is not particularly limited, but is preferably 250,000 or more to 500,000 or less. When the support includes such a polypropylene resin having the weight average molecular weight (Mw), the uniformity of the thickness of the support tends to be improved during film formation, and the strength or dielectric breakdown voltage also tends to be improved.

A molecular weight distribution (Mw/Mn) calculated as a ratio of the weight average molecular weight (Mw) to a number average molecular weight (Mn) of the polypropylene resin is not particularly limited, but is preferably 4 or more and 12 or less. When the support includes such a polypropylene resin having the molecular weight distribution (Mw/Mn), the uniformity of the thickness of the support tends to be improved during film formation, and the strength or insulating properties also tend to be improved.

The weight average molecular weight (Mw) and the number average molecular weight (Mn) of the polypropylene resin can be measured by a gel permeation chromatography (GPC) method. A GPC apparatus used for the GPC method is not particularly limited, and a commercially available high-temperature GPC measuring instrument capable of analyzing a molecular weight of the polyolefin resin, for example, a high temperature GPC measuring instrument with a built-in differential refractometer (RI) manufactured by Tosoh Corporation, HLC-8121GPC-HT, or the like can be used. In this case, for example, those in which three TSKgel GMHHR-H (20) HTs manufactured by Tosoh Corporation are connected are used as GPC column, a column temperature is set to be 145° C., trichlorobenzene is used as an eluent, and a flow rate is measured at 1.0 ml/min. Usually, a calibration curve is prepared using standard polystyrene, and the weight average molecular weight (Mw) and the number average molecular weight (Mn) can be obtained by polystyrene conversion.

A melting point of the polypropylene resin is preferably 155 to 175° C. In this case, since a melting point of the support containing the polypropylene resin is increased, the insulating properties of the double-sided adhesive tape or sheet at a high temperature are particularly improved. The insulating properties generally tend to be worsen as temperature rise, but electronic members and the like may generate heat during use, and when the double-sided adhesive tape or sheet is used for such members, it is required that the insulating properties are good even at high temperature. The melting point is more preferably 160 to 170° C.

In the present invention and the present specification, the melting point of the polypropylene resin is 155 to 175° C., which is defined by measurement by a differential scanning calorimeter (DSC) method. Specifically, in the measurement by the DSC of the polypropylene resin, in a DSC curve obtained when the temperature rises from 30° C. to 280° C. at a rate of 20° C./min and held at 280° C. for 5 minutes under a nitrogen flow, the cooling is made up to 30° C. at a rate of 20° C./min and held at 30° C. for 5 minutes, and then the temperature rises up to 280° C. at a rate of 20° ° C./min. when at least one melting peak is provided and the melting peak (maximum melting peak when indicating a plurality of melting peaks) is in a range of 155 to 175° C., the melting point of the polypropylene resin can be defined as 155 to 175° C.

The polypropylene resin can be produced using the conventionally known method. Examples of polymerization methods include a gas phase polymerization method, a bulk polymerization method, and a slurry polymerization method. The polymerization may be one-stage polymerization using one polymerization reactor, or may be multi-stage polymerization using two or more polymerization reactors. In addition, the polymerization may be performed by adding hydrogen or a comonomer as a molecular weight regulator in a reactor. As a polymerization catalyst, the conventionally known Ziegler-Natta catalyst, metallocene catalyst, or the like can be used, and the polymerization catalyst may contain a promoter component or a donor. The molecular weight, the molecular weight distribution, the stereoregularity, and the like of the polypropylene resin can be controlled by appropriately adjusting the polymerization catalyst and other polymerization conditions.

(Step of Forming Support)

The support can be formed using, for example, raw materials (hereinafter, also referred to as a polypropylene resin composition) containing the polypropylene resin. In the step of forming the support, for example, the polypropylene resin composition is extrusion-molded into a sheet form and is then biaxially stretched, thereby forming the support.

In the step of forming the support, the polypropylene resin contained in the polypropylene resin composition may be in a pellet form or a powder form. Alternatively, the polypropylene resin contained in the polypropylene resin composition may be a mixture of pellets and powder.

An extrusion molding method is not particularly limited. Examples of the extrusion molding method include a method for cooling and solidifying a polypropylene resin by supplying the polypropylene resin composition to an extruder, heating and melting the polypropylene resin at a predetermined temperature, passing the polypropylene resin through a filtration filter, melting and extruding the polypropylene resin from a T die, a ring die, or the like, and then air-cooling or water-cooling the polypropylene resin or bringing the polypropylene resin into contact with at least one metal drum to cool and solidify the polypropylene resin, and the like. Thereby, a raw fabric sheet is obtained. As the extruder, any of the known extruders such as a single screw extruder, a twin screw extruder, or a multistage extruder can be preferably used. The heating and melting temperature can be, for example, about 170° C. to 320° C., and preferably about 200° C. to 270° C. When a cooling metal drum is used, the temperature is usually kept at, for example, about 20° C. to 140° C., preferably about 40° C. to 130° C., and more preferably about 60° C. to 120° C.

Thus, the raw fabric sheet obtained in the step of forming the support may be used as the support as it is, but in order to obtain the preferable thickness of the support, it is preferable to stretch the raw fabric sheet. As examples of the stretching method, the known stretching methods such as a uniaxial stretching method or a biaxial stretching method can be used, but the biaxial stretching method is preferably performed to easily obtain the support having a preferable thickness with high accuracy and further increase the strength or insulating properties of the support. The biaxial stretching method includes a sequentially biaxial stretching method or a simultaneously biaxial stretching method, but from the viewpoint of easily improving the insulating properties, the simultaneously biaxial stretching method is preferable, but from the viewpoint of easily improving the thickness uniformity of the support, the sequentially biaxial stretching method is preferable, and therefore the biaxial stretching method can be selected according to the required quality.

The sequentially biaxial stretching method can be performed as follows, for example. First, the raw fabric sheet is preferably kept at a temperature of 100 to 180° C. and more preferably 120 to 170° C., passes between rolls having a peripheral speed difference, or is stretched preferably 2 to 10 times, more preferably 2.5 to 8 times, and still more preferably 3 to 6 times in a longitudinal direction by a tenter method. Subsequently, the stretched film is stretched preferably 2 to 12 times, more preferably 2.5 to 11.5 times, and still more preferably 3 to 11 times in a lateral direction at a temperature of preferably 100 to 180° C. and more preferably 120 to 175° C. by the tenter method, and then may be relaxed by about 5-10% in the lateral direction and subjected to heat relaxation and wound.

The simultaneously biaxial stretching method can be performed as follows, for example. First, the raw fabric sheet is preferably kept at a temperature of 100 to 180° C. and more preferably 130 to 175° C., and is stretched preferably 2 to 10 times, more preferably 3 to 9 times, and still more preferably 4 to 8 times in the longitudinal direction and at the same time, preferably 2 to 12 times, more preferably 3 to 11.5 times, and still more preferably 4 to 11 times in the lateral direction, and then may be relaxed by about 5 to 10% in the longitudinal and lateral directions and subjected to the heat relaxation and wound.

The thickness (Dp) of the support is preferably 1.5 to 6 μm. Within this range, the total thickness (Ds) of laminate and the value of the Dp/Ds are easily adjusted to be a predetermined range, and furthermore, the double-sided adhesive tape or sheet is excellent in lightness, strength, and insulating properties. The thickness (Dp) of the support is more preferably 1.7 to 5 μm, and still more preferably 1.9 to 4 μm. The thickness (Dp) of the support can be adjusted by, for example, production conditions in the step of forming the support. For example, the thickness (Dp) of the support can be adjusted by adjusting the stretch ratio when the raw fabric sheet is biaxially stretched. Further, the thickness of the raw fabric sheet can be adjusted by, for example, an extrusion amount, a take-up speed, and the like at the time of the extrusion molding.

The density of support is preferably 0.90 to 0.94 g/cm³. By setting the density of the support to be 0.90 g/cm³ or more, the strength or insulating properties are improved. By setting the density of the support to be 0.94 g/cm³ or less, the stretching productivity and thickness accuracy are improved, the embrittlement during the low temperature use is suppressed, and the weight is reduced. The density of the support is more preferably 0.905 g/cm³ or more, still more preferably 0.91 g/cm³ or more, and particularly preferably 0.913 g/cm³ or more. The density of the support is more preferably 0.935 g/cm³ or less, still more preferably 0.93 g/cm³ or less, and particularly preferably 0.925 g/cm³ or less. The density of the support can be adjusted by, for example, the amount of isotactic homopolypropylene added or the mesopentad fraction, the stretch ratio during the stretching or the stretching temperature, or the like.

The support may have either a single layer structure or a laminated structure, and the structure is not limited. When the support has the laminated structure, the composition of each layer may be the same, or a part or all of the layers may have different compositions.

One side or the both surfaces of the support may be subjected to oxidation treatment and the like by a chemical or physical method such as chromic acid treatment, ozone exposure, flame exposure, high piezoelectric exposure, and ionizing radiation treatment. In this case, adhesion between the support and the adhesive agent layer is enhanced, and delamination between the support and the adhesive agent layer is suppressed.

(Adhesive Agent Layer)

The adhesive agent layer is a layer that exhibits the adhesiveness ability as the double-sided adhesive tape or sheet.

The adhesive agent layer is disposed so as to contact a main surface of a back surface or a front surface of the support. Here, in the present invention and the present specification, the adhesive agent layer disposed so as to contact the back surface of the support is also referred to as a first adhesive agent layer, and the adhesive agent layer disposed so as to contact the front surface of the support is referred to as a second adhesive agent layer. As described above, each adhesive agent layer is represented as a first adhesive agent layer 12a and a second adhesive agent layer 12b in FIG. 1.

The adhesive agent layer contains an acrylic polymer. More specifically, the adhesive agent layer contains the acrylic polymer as a main component. The adhesive agent layer may contain components other than the acrylic polymer. The component other than the acrylic polymer is the same as the component that may be included as a component other than the acrylic polymer in an acrylic adhesive composition described later. Therefore, the above components are omitted herein.

As the acrylic polymer contained in the adhesive agent layer, an acrylic copolymer containing a (meth)acrylic ester unit (a1) is preferable. In particular, from the viewpoint of the adhesiveness, it is more preferable that the adhesive agent layer contains as a main component the acrylic copolymer containing the (meth)acrylic ester unit (a1). Among them, the acrylic copolymer containing the (meth)acrylic ester unit (a1) is more preferably crosslinked. Here, the (meth)acrylic ester unit (a1) will be described later.

The adhesive agent layer is a layer in which the acrylic adhesive composition is solidified. In other words, the adhesive agent layer is a layer obtained by solidifying the acrylic adhesive composition. Here, the solidified layer includes one of (i) a state in which the solvent in the acrylic adhesive composition is removed and the acrylic polymer or the like is formed as a layer, and (ii) a state in which the acrylic polymer in the acrylic adhesive composition is crosslinked and formed as a layer, (iii) a state in which the molten acrylic adhesive composition is cooled and formed as a layer, and (iv) a state in which two or more of the above (i) to (iii) are combined.

The acrylic adhesive composition may contain as a main component a polymer having adhesiveness using acrylic acid ester or methacrylic acid ester as a main monomer unit, but in particular, if the acrylic adhesive composition contains as a main component a crosslinkable acrylic copolymer (A) which contains noncrosslinkable(meth)acrylic ester unit (a1) and an acrylic monomer unit (a2) having a crosslinkable functional group, the adhesion between the acrylic adhesive agent layer and the support is improved, and it is preferable to rarely cause problems such as the delamination between the support and the adhesive agent layer. In addition, it is preferable that the acrylic adhesive composition contains a crosslinking agent (B) in order to further improve the adhesion between the acrylic adhesive agent layer and the support.

Note that in the present specification, “(meth)acrylic acid” represents both or one of acrylic acid and methacrylic acid, and “(meth)acrylate” represents both or one of acrylate and methacrylate. In addition, in the present specification, “unit” is a repeating unit (monomer unit) constituting a polymer.

(Crosslinkable Acrylic Copolymer (A))

The crosslinkable acrylic copolymer (A) contains the noncrosslinkable(meth)acrylic ester unit (a1) and the acrylic monomer unit (a2) having the crosslinkable functional group.

The noncrosslinkable(meth)acrylic ester unit (a1) is a repeating unit derived from (meth)acrylic acid alkyl ester. Examples of the (meth)acrylic acid alkyl esters include methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, n-pentyl(meth)acrylate, n-hexyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-undecyl(meth)acrylate, n-dodecyl(meth)acrylate, stearyl(meth)acrylate, methoxyethyl(meth)acrylate, ethoxyethyl(meth)acrylate, cyclohexyl(meth)acrylate, benzyl(meth)acrylate, and the like. These may be used alone or in combination of two or more.

Among the (meth)acrylic acid alkyl esters, at least one selected from methyl(meth)acrylate, n-butyl(meth)acrylate, and 2-ethylhexyl(meth)acrylate is preferable to increase the adhesiveness.

Examples of the acrylic monomer unit (a2) having the crosslinkable functional group include a hydroxyl group-containing monomer unit, an amino group-containing monomer unit, a glycidyl group-containing monomer unit, a carboxy group-containing monomer unit, and the like. These monomer units may be one type or two or more types.

The hydroxy group-containing monomer unit is a repeating unit derived from a hydroxy group-containing monomer. Examples of the hydroxy group-containing monomer include hydroxyalkyl(meth)acrylate such as 2-hydroxyethyl(meth)acrylate, 4-hydroxybutyl(meth)acrylate, and 2-hydroxypropyl(meth)acrylate. (meth)acrylic acid [(mono, di or poly)alkylene glycol] such as (meth)acrylic acid mono(diethylene glycol), (meth)acrylic acid lactone such as (meth)acrylic acid monocaprolactone, and the like.

Examples of the amino group-containing monomer unit include a repeating unit derived from the amino group-containing monomer such as (meth)acrylamide and allylamine.

Examples of the glycidyl group-containing monomer unit include a repeating unit derived from the glycidyl group-containing monomer such as glycidyl(meth)acrylate.

Examples of the carboxyl group-containing monomer unit include acrylic acid and methacrylic acid.

As a combination of the noncrosslinkable(meth)acrylic ester unit (a1) and the acrylic monomer unit (a2) having the crosslinkable functional group contained in the crosslinkable acrylic copolymer (A), preferably, the noncrosslinkable(meth)acrylic ester unit (a1) is at least one selected from the group consisting of n-butyl(meth)acrylate and methyl(meth)acrylate and the acrylic monomer unit (a2) having the crosslinkable functional group is (meth)acrylic acid, more preferably, the noncrosslinkable(meth)acrylic ester unit (a1) is at least one selected from the group consisting of n-butyl acrylate and methyl acrylate and the acrylic monomer unit (a2) having the crosslinkable functional group is acrylate, and particularly preferably, the noncrosslinkable(meth)acrylic ester unit (a1) is two types of n-butyl acrylate and methyl acrylate and the acrylic monomer unit (a2) having the crosslinkable functional group is acrylate.

The content of the crosslinkable acrylic monomer unit (a2) in the crosslinkable acrylic copolymer (A) is preferably 0.01 to 20% by mass as a ratio occupied in the total monomer mass constituting the copolymer. The content is more preferably 0.1 to 15% by mass, still more preferably 0.5 to 10% by mass, and particularly preferably 1 to 10% by mass. The content of the crosslinkable acrylic monomer unit (a2) is within the above range, so crosslinkability can be sufficiently exerted, and further necessary adhesive physical properties can be maintained. In particular, when the noncrosslinkable(meth)acrylic ester unit (a1) is two types of n-butyl acrylate and methyl acrylate, and the acrylic monomer unit (a2) having the crosslinkable functional group is acrylic acid, it is preferable that the n-butyl acrylate monomer unit is 45 to 84% by mass, the methyl acrylate monomer unit is 15 to 54% by mass, and the acrylic acid monomer unit is 1 to 10% by mass. When the monomer unit component and the monomer unit content in the crosslinkable acrylic copolymer (A) each are the above-described preferable components and content ranges, the adhesive agent layer and the support containing the polypropylene resin are not peeled off, and the adhesive agent layer having the adhesive force described later can be formed more preferably.

The crosslinkable acrylic copolymer (A) may have other monomer units other than the noncrosslinkable(meth)acrylic ester unit (a1) and the acrylic monomer unit (a2) having the crosslinkable functional group, if necessary. The other monomers may be those that can be copolymerized with the noncrosslinkable(meth)acrylic ester and the acrylic monomer having the crosslinkable functional group, and examples thereof include (meth)acrylonitrile, vinyl acetate, styrene, vinyl chloride, vinyl pyrrolidone, vinyl pyridine, and the like. The content of the optional monomer unit in the crosslinkable acrylic copolymer (A) is preferably 0 to 20% by mass, and more preferably 0 to 15% by mass.

The weight average molecular weight of the crosslinkable acrylic copolymer (A) is preferably 100,000 to 2,000,000, more preferably 200,000 to 1,500,000, and still more preferably 400,000 to 1,000,000. By setting the weight average molecular weight to be within the above range, the necessary adhesive properties can be maintained, and the sufficient irregularities followability can be secured. Note that the weight average molecular weight of the crosslinkable acrylic copolymer (A) is a value before the crosslinkable acrylic copolymer is crosslinked with the crosslinking agent (B) or the like. The weight average molecular weight is a value which is determined by size exclusion chromatography (SEC) and determined on a polystyrene basis. As the crosslinkable acrylic copolymer (A), commercially available products may be used, or products synthesized by the known method may be used.

(Crosslinking Agent(B))

The acrylic adhesive composition preferably contains a crosslinking agent (B) in order to adjust the adhesive force, improve the durability of the adhesive layer, improve the adhesion with the support, and the like. The crosslinking agent (B) is a component for crosslinking the crosslinkable acrylic copolymer (A). In particular, the crosslinking agent (B) is a component which can react with the crosslinkable functional group of the crosslinkable acrylic monomer unit (a2) in the crosslinkable acrylic copolymer (A). The type of the crosslinking agent (B) is not particularly limited as long as the crosslinking agent (B) can react with the crosslinkable functional group of the crosslinkable acrylic monomer unit (a2), and the known crosslinking agents can be widely used.

Examples of the crosslinking agent (B) include an isocyanate compound, an epoxy compound, an oxazoline compound, an aziridine compound, a metal chelate compound, a butylated melamine compound, and the like, and these may be used in combination of two or more, if necessary, and are preferably selected in consideration of the reactivity with the functional group used in the crosslinkable acrylic copolymer (A).

Among these crosslinking agents, at least one selected from the group consisting of the isocyanate compound and the epoxy compound is preferable, and the epoxy compound is more preferable since the crosslinkable acrylic copolymer (A) can be easily crosslinked. Examples of the isocyanate compound include tolylene diisocyanate, xylylene diisocyanate, hexamethylene diisocyanate, isophorone diisocyanate, and the like. As the epoxy compound, an epoxy compound containing two or more epoxy groups is preferable. Examples of the epoxy compound containing two or more epoxy groups include ethylene glycol diglycidyl ether, polyethylene glycol diglycidyl ether, propylene glycol diglycidyl ether, polypropylene glycol diglycidyl ether, glycerin diglycidyl ether, neopentyl glycol diglycidyl ether, 1,6-hexanediol diglycidyl ether, tetraglycidylxylenediamine (in particular, N,N,N′,N′-tetraglycidyl-m-xylenediamine), 1,3-bis(N,N-diglycidylaminomethyl)cyclohexane, trimethylolpropane polyglycidyl ether, diglycerol polyglycidyl ether, polyglycerol polyglycidyl ether, sorbitol polyglycidyl ether, and the like. From the viewpoint that the crosslinking agent can more suitably form an adhesive agent layer having an adhesive force described later without peeling off the adhesive agent layer and the support containing the polypropylene resin, in particular, at least one selected from the group consisting of N,N,N′,N′-tetraglycidyl-m-xylenediamine and 1,3-bis(N,N-diglycidylaminomethyl)cyclohexane is preferable. It is assumed that the reason why at least one selected from the above group is preferred as the crosslinking agent is that the crosslinkable acrylic polymer contained in the adhesive agent layer and the specific crosslinking agent having an amine structure and/or a six-membered ring construct a uniform three-dimensional network structure, and the balance between the wettability and the cohesive force is optimized between the support containing the polypropylene resin and the adhesive agent layer in which the three-dimensional network structure is constructed. As such an epoxy compound, for example, those commercially available under trade names such as “TETRAD (registered trademark)-C”, “TETRAD (registered trademark)-X” [manufactured by Mitsubishi Gas Chemical Company, Inc.] can be preferably used.

In the acrylic adhesive composition, the content of the crosslinking agent is appropriately selected according to the desired adhesive physical properties and is not particularly limited, but for example, it is preferably 0.001 to 3 parts by mass, more preferably 0.005 to 1 part by mass, and still more preferably 0.01 to 0.1 parts by mass with respect to 100 parts by mass of the crosslinkable acrylic copolymer (A). Since the adhesive agent layer is very thin, the adhesive agent layer has excellent durability even when the content of the crosslinking agent is 0.001 parts by mass, and has the excellent adhesion to the adherend as long as the content of the crosslinking agent is equal to or lower than the upper limit.

As the crosslinking agent (B), one type may be used alone, or two or more types may be used in combination, and when two or more types are used in combination, the total mass is preferably within the above range.

(Other Components)

The acrylic adhesive composition may contain other components. Examples of the other components include a polymerization initiator, a plasticizer, and optional components.

The polymerization initiator is not particularly limited as long as it can initiate the crosslinking polymerization reaction of the acrylic monomer unit (a2) having the crosslinkable functional group contained in the crosslinkable acrylic copolymer (A) by irradiation of active energy rays, and the known materials such as a photopolymerization initiator can be used. The polymerization initiator can be added for the purpose of, for example, adjusting the crosslinking density of the adhesive agent layer, improving the adhesion between the support and adhesive agent layer, and the like.

Here, the “active energy rays” mean those having energy quantum among electromagnetic waves or charged particle beams, and examples thereof include ultraviolet rays, electron beams, visible rays, X-rays, ion rays, and the like. Among these, from the viewpoint of versatility, the ultraviolet rays or the electron beams are preferable, and the ultraviolet rays are particularly preferable. Note that when the ultraviolet rays or the visible rays are used as the active energy rays, it is preferable to select transparent ones having good transparency for the support and a separator described later.

Examples of the polymerization initiator include acetophenone-based initiators, benzoin ether-based initiators, benzophenone-based initiators, hydroxyalkylphenone-based initiators, thioxanthone-based initiators, amine-based initiators, and the like.

Specific examples of the acetophenone-based initiators include diethoxyacetophenone, benzyldimethyl ketal, and the like.

Specific examples of the benzoin ether-based initiators include benzoin, benzoin methyl ether, and the like.

Specific examples of the benzophenone-based initiator include benzophenone, methyl o-benzoylbenzoate, and the like.

Specific examples of the hydroxyalkylphenone-based initiators include 1-hydroxy-cyclohexyl-phenyl-ketone and the like.

Specific examples of the thioxanthone-based initiators include 2-isopropylthioxanthone, 2,4-dimethylthioxanthone, and the like.

Specific examples of the amine-based initiators include triethanolamine, ethyl 4-dimethylbenzoate, and the like.

The content of the polymerization initiator in the adhesive composition is appropriately selected according to the content of the acrylic monomer unit (a2) having the crosslinkable functional group contained in the crosslinkable acrylic copolymer (A), the irradiation amount of the active energy rays, or the like. Specifically, the content of the polymerization initiator is preferably 0.01 to 5% by mass and more preferably 0.02 to 2% by mass with respect to 100 parts by mass of the crosslinkable acrylic copolymer (A). If the content of the polymerization initiator is equal to or greater than the above lower limit, the polymerization reaction can be easily started, and if the content of the polymerization initiator is equal to or lower than the above lower limit, the damage to the support or the separator due to the influence of the polymerization reaction heat during the polymerization is less likely to occur.

The acrylic adhesive composition may include a plasticizer. By including the plasticizer, the double-sided adhesive tape or sheet of the present invention can fill a step formed on the adherend, and the irregularities followability is improved. The plasticizer is preferably a non-functional acrylic polymer. The non-functional acrylic polymer is a polymer composed of only an acrylic monomer unit having no functional group other than an acrylate group, or a polymer composed of an acrylic monomer unit having no functional group other than an acrylate group and a non-acrylic monomer unit having no functional group. Since the non-functional acrylic polymer is not crosslinked with the crosslinkable acrylic copolymer (A), it is possible to improve the irregularities followability without affecting the adhesive physical properties.

Examples of the acrylic monomer unit having no functional group other than the acrylate group include those similar to the noncrosslinkable(meth)acrylic ester unit (a1).

Examples of the non-acrylic monomer unit having no functional group include carboxylic acid vinyl esters such as vinyl acetate, vinyl propionate, vinyl butyrate, vinyl caproate, vinyl caprylate, vinyl caprate, vinyl laurate, vinyl myristate, vinyl palmitate, vinyl stearate, vinyl cyclohexanecarboxylate, and vinyl benzoate, styrene, or the like.

The acrylic adhesive composition may contain optional components as long as the effects of the present invention are not impaired. As the optional components, the well-known component can be used as an additive for an adhesive. For example, an antioxidant, a metal corrosion inhibitor, a tackifier, a silane coupling agent, an ultraviolet absorber, a light stabilizer such as a hindered amine compound, and the like can be selected if necessary.

Examples of the antioxidant include phenolic antioxidants, amine-based antioxidants, lactone-based antioxidants, phosphorus-based antioxidants, sulfur-based antioxidants, and the like. These antioxidants may be used alone or in combination of two or more.

As the metal corrosion inhibitor, a benzoriazol resin can be used as a preferred example for the high compatibility and effect of the adhesive.

Examples of the tackifier include rosin-based resins, terpene-based resins, terpene phenol-based resins, coumarone indene-based resins, styrene-based resins, xylene-based resins, phenol-based resins, petroleum resin, and the like.

Examples of the silane coupling agent include mercaptoalkoxysilane compounds (for example, mercapto group-substituted alkoxy oligomers, and the like).

Examples of the ultraviolet absorber include benzotriazole-based compounds and benzophenone-based compounds. However, when the ultraviolet rays as the above-described active energy rays are used, the ultraviolet absorber needs to be added in a range that does not inhibit the polymerization reaction.

Any of the two adhesive agent layers formed on the both surfaces of the support may have the same component composition or different component compositions.

(Step of Forming Adhesive Agent Layer)

The adhesive agent layer can be formed using the acrylic adhesive composition.

The adhesive agent layer may be applied with, for example, a method for laminating and extrusion-molding an acrylic adhesive composition with a polypropylene resin composition that forms a support and then stretching the extrusion-molded product, a method for extruding (laminating) an acrylic adhesive composition on a raw fabric sheet of a support and then stretching the acrylic adhesive composition together with the raw fabric sheet of the support, a method for stretching an acrylic adhesive composition together with a raw fabric sheet of a support after coating the an acrylic adhesive composition on the raw fabric sheet of the support, a method for extruding (laminating) an acrylic adhesive composition on a support, a method for coating an acrylic adhesive composition on a support, a method for bonding an adhesive agent layer, which is formed by extruding or coating an acrylic adhesive composition on another base material (for example, separator to be described later, and the like), to a support, and the like. Among these, from the viewpoint of easily controlling the thickness of the ultra-thin adhesive agent layer with accuracy as in the present invention, the method of coating an acrylic adhesive composition on a support or the method of coating an acrylic adhesive composition on another base material and bonding an adhesive agent layer to a support is preferable.

When the adhesive agent layer is formed by coating, the acrylic adhesive composition may be solvent-free and furthermore may contain a solvent for dissolving and/or dispersing the components contained therein.

The solvent is not particularly limited as long as it can dissolve and/or disperse the acrylic adhesive composition, and examples of the solvent include hydrocarbons such as hexane, heptane, octane, toluene, xylene, ethylbenzene, cyclohexane, and methylcyclohexane; halogenated hydrocarbons such as dichloromethane, trichloroethane, trichloroethylene, tetrachloroethylene, dichloropropane; alcohols such as methanol, ethanol, propanol, isopropyl alcohol, butanol, isobutyl alcohol, diacetone alcohol; ethers such as diethyl ether, diisopropyl ether, dioxane, tetrahydrofuran; ketones such as acetone, methyl ethyl ketone, methyl isobutyl ketone, isophorone, cyclohexanone; esters such as methyl acetate, ethyl acetate, butyl acetate, isobutyl acetate, amyl acetate, and ethyl butyrate; polyols such as ethylene glycol monomethyl ether, ethylene glycol monoethyl ether, ethylene glycol monomethyl ether acetate, propylene glycol monomethyl ether, propylene glycol monoethyl ether, propylene glycol monomethyl ether acetate and derivatives thereof, and the like.

As the solvent, a solvent having no polymerizable unsaturated group and having a high vapor pressure at 25° C. is preferable since the solvent has few coating defects and is easily produced. The vapor pressure of the solvent is preferably 2000 Pa or more, and particularly preferably 5000 Pa or more. The upper limit is not particularly limited, but is preferably 50,000 Pa or less for practical use. The vapor pressure of the solvent (E) can be measured by JIS K2258-2 “Crude petroleum and petroleum products-Determination of vapor pressure-Part 2: Triple expansion method”.

The solvent preferably has a surface tension of 20 mN/m or more and less than 40 mN/m at 25° C., and more preferably a surface tension of 22 mN/m or more and less than 36 N/m. If the surface tension is not less than the lower limit of the above range, application defects such as orange peel are less likely to occur, and if the surface tension is less than the upper limit of the above range, application defects such as a thick portion (framing) are less likely to occur.

A boiling point of the solvent is preferably 10 to 150° C. and more preferably 20 to 120° C. from the viewpoint of easy handling ability of a coating liquid and easy production efficiency of the adhesive agent layer.

Preferred solvents for the present invention include hexane, heptane, cyclohexane, benzene, toluene, ethanol, isopropyl alcohol, diisopropyl ether, tetrahydrofuran, acetone, methyl ethyl ketone, methyl isobutyl ketone, ethyl acetate, and the like. These may be used alone or in combination of two or more.

The solid content concentration of the acrylic adhesive composition in the case of containing the solvent is preferably 1 to 90% by mass, more preferably 10 to 80% by mass, and still more preferably 20 to 70% by mass based on a total amount of the coating liquid, from the viewpoint of the stability and coating suitability of the coating liquid.

The coating method is not particularly limited, and for example, various known coating apparatuses can be used. Examples of the coating apparatuses include a roll coater, a bar coater, a kiss roll coater, a gravure coater, a micro gravure coater, a rod coater, a blade coater, an air knife coater, a lip coater, a die coater, and a curtain coater.

When the acrylic adhesive composition contains the solvent, the known heating device such as a heating furnace (dryer) or an infrared lamp can be used during the step of drying the solvent.

When the acrylic adhesive composition contains the above-described polymerization initiator, a coating film of the acrylic adhesive composition containing the polymerization initiator, a semi-dried coating film during the drying, a dried coating film, the adhesive agent layer formed by a melt extrusion method, or the like is preferably irradiated with the above-described active energy rays. The active energy rays can be selected appropriately depending on the polymerization initiator used.

The thickness of the adhesive agent layer is not particularly limited as long as the total thickness Ds and the value of the Dp/Ds satisfy a specific range. For example, the thickness of the adhesive agent layer can be 1 to 6 μm. This range is preferable because the total thickness Ds and the value of the Dp/Ds can be easily adjusted to be a predetermined range and a high adhesive force can be obtained. Here, the thickness of the adhesive agent layer points out a thickness of one of the two adhesive agent layers formed on the both surfaces of the support. The thickness of the adhesive agent layer is more preferably 1.5 to 5.5 μm, and still more preferably 2 to 5 μm.

The thickness of the adhesive agent layer can be adjusted, for example, by adjusting the solid content concentration or application amount of the acrylic adhesive composition.

Note that any of the two adhesive agent layers formed on the both surfaces of the support may have the same thickness or different component compositions.

The adhesive agent layer is preferably formed on the entire surface of each of the both surfaces of the support from the viewpoint that the double-sided adhesive tape or sheet secures a high adhesive strength

The adhesive agent layer may have any form of a single layer structure and a laminated structure, and the structure is not restricted. When the adhesive agent layer has the laminated structure, the composition of each layer may be the same, or a part or all of the layers may have different compositions.

(Laminate)

The laminate includes a support and two adhesive agent layers (first adhesive agent layer and second adhesive agent layer) formed on the both surfaces of the support.

In the present invention, the total thickness Ds of the laminate is 4 to 15 μm, and the value of the Dp/Ds, which is the ratio between the thickness Dp of the support and the total thickness Ds of the laminate, is 0.15 to 0.6. The total thickness Ds of the laminate is the sum of the thicknesses of the support, the first adhesive agent layer, and the second adhesive agent layer. When the total thickness Ds and the value of the Dp/Ds each satisfy the above ranges, the double-sided adhesive tape or sheet is excellent in the strength, the adhesiveness, and the insulating properties even if the thickness of the double-sided adhesive tape or sheet is thin and the double-sided adhesive tape or sheet is light-weight. In addition, when the total thickness Ds and the value of the Dp/Ds satisfy the above range, the double-sided adhesive tape or sheet is less likely to cause wrinkles during the bonding and the like, and the bonding work can be easily performed.

In this way, in the double-sided adhesive tape or sheet of the present invention, in addition to the thickness Dp of the support, the ratio of the thickness Dp of the support to the total thickness Ds of the laminate is also adjusted to be an appropriate range, and thus the double-sided adhesive tape or sheet is configured to be excellent in various physical properties such as the strength, the adhesiveness, and the insulating properties.

When the total thickness Ds of the laminate is less than 4 μm, the adhesiveness of the double-sided adhesive tape or sheet is inferior, and the bonding becomes difficult. In addition, if the total thickness Ds of the laminate exceeds 15 μm, the double-sided adhesive tape or sheet becomes too thick, and is hard to apply for small and thin electronic devices, and thus the range of applications of the double-sided adhesive tape or sheet is limited.

The total thickness Ds is preferably 5 μm or more, more preferably 6 μm or more, and still more preferably 7 μm or more. In addition, the total thickness Ds is preferably 14 μm or less, more preferably 13 μm or less, and still more preferably 12 μm or less.

When the value of the Dp/Ds is less than 0.15, the rupture strength of the laminate is lowered, and the double-sided adhesive tape or sheet is easily broken or damaged. In addition, if the value of the Dp/Ds exceeds 0.6, the ratio of the support to the total thickness of the laminate becomes too high, thereby causing the decrease in the adhesiveness and irregularities followability.

The value of the Dp/Ds is preferably 0.18 or more, more preferably 0.21 or more, still more preferably 0.24 or more, and particularly preferably 0.25 or more. Further, the Dp/Ds is preferably 0.5 or less, more preferably 0.45 or less, still more preferably 0.4 or less, further still more preferably 0.35 or less, and particularly preferably 0.30 or less.

The density of the laminate is 0.90 to 1.10 g/cm³. By setting the density of the laminate to be 0.90 g/cm³ or more, the strength or insulating properties are improved. By setting the density of the laminate to be 1.10 g/cm³ or less, the good adhesive force is exhibited and the irregularities followability is improved even when the thickness of the double-sided adhesive tape or sheet is thin. The density of the laminate is more preferably 0.92 g/cm³ or more, still more preferably 0.95 g/cm³ or more, and still more preferably 0.97 g/cm³ or more. The density of the laminate is preferably 1.07 g/cm³ or less, more preferably 1.06 g/cm³ or less, still more preferably 1.05 g/cm³ or less, and particularly preferably 1.04 g/cm³ or less. From the viewpoint of the excellent strength, adhesiveness and insulating properties even if the thickness of the double-sided adhesive tape or sheet is thin and the double-sided adhesive tape or sheet is light-weight, as the combination of the density of the laminate and the ratio Dp/Ds of this embodiment, it is preferable that the density of the laminate of 0.90 to 1.07 g/cm³ and the Dp/Ds is 0.18 to 0.35, it is more preferable that the density of the laminate is 0.90 to 1.06 g/cm³ and the Dp/Ds is 0.18 to 0.35, and it is still more preferable that the density of laminate is 0.90 to 1.05 g/cm³ and the Dp/Ds is 0.18 to 0.30. The density of the laminate can be adjusted by the density of the support or the crosslinking density of the adhesive agent layer.

If the rupture strength (rupture strength in a flow direction and rupture strength in a width direction) of the laminate is 30 to 180 MPa, the balance of the strength, bondability, adhesiveness, and irregularities followability of the double-sided adhesive tape or sheet is good. By setting the rupture strength to be 30 MPa or more, the strength is excellent, and the wrinkles are less likely to occur during the bonding, and the bonding operation can be easily performed. By setting the rupture strength to be 180 MPa or less, the adhesiveness and irregularities followability are improved. The rupture strength is more preferably 35 to 150 MPa, more preferably 45 to 120 MPa. and particularly preferably 50 to 110 MPa.

Herein, the flow direction of the laminate corresponds to the longitudinal direction of the laminate, and the width direction of the laminate corresponds to the transverse direction of the laminate. For example, when the support constituting the laminate is obtained by extrusion molding, the extrusion direction coincides with the flow direction.

The dielectric breakdown voltage of the laminate is preferably 1 to 6 kV to obtain the excellent insulating properties. In this case, even when the double-sided adhesive tape or sheet is applied to members, such as a secondary battery, that require the insulating properties, the deterioration of the double-sided adhesive tape or sheet is suppressed over a long period of time, and the double-sided adhesive tape or sheet is excellent in the insulation durability. In particular, from the viewpoint of improving the insulation durability, the dielectric breakdown voltage of the laminate is more preferably 1.5 kV or more, still more preferably 2 kV or more, and particularly preferably 2.3 kV or more. The upper limit of the dielectric breakdown voltage is usually 6 kV or less, but may be 5 kV or less, and further 4 kV or less.

The adhesive force of the first adhesive agent layer of the laminate and the adhesive force of the second adhesive agent layer of the laminate each are preferably 1 N/25 mm or more, more preferably 1.5 N/25 mm or more, and still more preferably 2 N/25 mm or more, from the viewpoint of easily improving the adhesion to the adherend described later, for example. In addition, the adhesive force of the first adhesive agent layer of the laminate and the adhesive force of the second adhesive agent layer of the laminate each are preferably 6 N/25 mm or less, more preferably 5 N/25 mm or less, and still more preferably 4 N/25 mm or less, and particularly preferably 3 N/25 mm or less from the viewpoint of easily improving the peelability to the adherend described later, for example. In particular, the adhesive force of the first adhesive agent layer and the adhesive force of the second adhesive agent layer of the laminate each are 2 N/25 mm or more and 4 N/25 mm or less (furthermore, 2 N/25 mm or more and 3 N/25 mm or less) is a preferred aspect from the viewpoints of the adhesion and peelability.

The double-sided adhesive tape or sheet of the present invention includes only the laminate that includes the support and the two adhesive agent layers (first adhesive agent layer and second adhesive agent layer) formed on the both surfaces of the support. Alternatively, as long as it does not inhibit the effect of the present invention, the double-sided adhesive tape or sheet of the present invention may include the laminate and furthermore may have other layers.

Examples of other layers include a release treatment layer. The release treatment layer is, for example, a layer that adjusts adhesive force so that the double-sided adhesive tape or sheet can be easily peeled off even after being attached to the adherend of metal, plastic, film, and the like. The release treatment layer can be formed, for example, on a surface of an outer side of the adhesive agent layer of one surface or both surfaces of the laminate. The material for forming the release treatment layer is not particularly limited, and the release treatment layer may be formed from release agents such as a silicone release agent, a fluorine release agent, and a long-chain alkyl release agent.

2. Laminated Tape or Sheet

By using the double-sided adhesive tape or sheet of the present invention, the laminated tape or sheet can be formed.

For example, the laminated tape or sheet can be formed including the double-sided adhesive tape or sheet of the present invention and the separator. In the laminated tape or sheet, the separator can be formed on the outer side of the adhesive agent layer on at least one side of the double-sided adhesive tape or sheet. Alternatively, the separator can be formed on outer sides of each of the adhesive agent layer on both sides of the double-sided adhesive tape or sheet. Note that the outer side of the adhesive agent layer refers to the surface of the adhesive agent layer opposite to the support.

Herein, the separator is a member for protecting the adhesive agent layer and preventing blocking.

FIG. 2 shows an example of the laminated tape or sheet, and shows a cross-sectional view of the laminated tape or sheet. The laminated tape or sheet 2 in the form of FIG. 2 is formed to include the double-sided adhesive tape or sheet 1 and a pair of separators 13. Each of the pair of separators 13 is disposed to face the outer sides of each of the adhesive agent layers 12 (that is, the first adhesive agent layer and the second adhesive agent layer) on both sides of the double-sided adhesive tape or sheet 1. The double-sided adhesive tape or sheet 1 has the same configuration as that shown in FIG. 1, and is formed to include only the laminate 10.

(Separator)

The separator in the laminated tape or sheet of the present invention has peelability. Examples of the laminated configuration of the separator include (i) a single-layer configuration including only a base material, and (ii) a configuration having two or more layers in which a base material and a release layer are sequentially formed. Here, the separator includes at least a base material.

In the above aspect (i), the base material is preferably made of a material having high peelability. In the above aspect (ii), the base material may be made of a material having high peelability, or may be made of a material having low peelability. When the base material is made of a material having low peelability, it is preferable that the release layer is formed on one side and/or both surfaces of the base material.

As a material constituting the base material, the known film or sheet, paper, nonwoven fabric, cloth, foamed sheet, metal foil, and a composite base material made of these various base materials, and the like can be optionally used. Examples of the film include a polyethylene-based film (more specifically, high density polyethylene, medium density polyethylene, low density polyethylene, linear low density polyethylene, metallocene catalyst-based linear low density polyethylene film, and the like). A polypropylene-based film, a polymethylpentene-based film, a cyclic olefin-based film, an ethylene-cyclic olefin copolymer-based film a polyvinyl chloride-based film, a polyvinylidene chloride-based film, a polyvinyl alcohol-based film, an ethylene-polyvinyl alcohol copolymer-based film, an ethylene-vinyl acetate copolymer-based film, an ethylene-methacrylic acid copolymer-based film, a polyester-based film (more specifically, a polyethylene terephthalate film, a polyethylene naphthalate film, and the like), a polycarbonate-based film, a polystyrene-based film, a syndiotactic polystyrene-based film, a polyacrylonitrile-based film, a polyamide (nylon)-based film a polyimide-based film, a polyetheretherketone-based film, a polyphenylene sulfide-based film, a fluorine-based film (more specifically, polytetrafluoroethylene (Teflon (registered trademark)) film, polyvinylidene fluoride film, and the like) may be suitably used for both stretched and unstretched products.

Among these, the polyethylene-based film, the polypropylene-based film, and the polyethylene terephthalate-based film are preferable from the viewpoint of the good balance of strength and flexibility, the excellent thickness accuracy, and the availability at low cost, and in particular, a biaxially oriented polypropylene film and a biaxially oriented polyethylene terephthalate-based film are preferable.

The release layer of the separator can be formed from release agents such as a silicone-based release agent, a fluorine-based release agent, or a long-chain alkyl-based release agent.

Among these, the silicone-based release agent is preferably used, and an additional type silicone-based release agent is particularly preferable. Specific examples of the additional type silicone-based release agents include BY24-4527, SD-7220, and the like manufactured by Dow Corning Toray Co., Ltd, or KS-3600, KS-774, X62-2600, and the like manufactured by Shin-Etsu Chemical Co., Ltd.

In addition, a silicone resin that is an organosilicon compound having SiO₂ units and (CH₃)₃SiO_{1/2} units or CH₂═CH(CH₃)SiO_{1/2} units is preferably contained in the silicone-based release agent. Specific examples of the silicone resin include BY24-843, SD-7292, SHR-1404, and the like manufactured by Dow Corning Toray Co., Ltd, or KS-3800, X92-183, and the like manufactured by Shin-Etsu Chemical Co., Ltd.

The thickness of the separator is not particularly limited, and can be in an appropriate range depending on the use purpose. The thickness of the separator is generally about 10 to 500 μm.

The separator may be provided, for example, so as to cover all the surfaces of the first adhesive agent layer and the second adhesive agent layer that are each disposed on an outermost layer of the laminate. The separator that covers the first adhesive agent layer may be referred to as a first separator, and the separator that covers the second adhesive agent layer may be referred to as a second separator.

In the laminated tape or sheet, when the separator is formed only on the outer side of the adhesive agent layer on one side of the double-sided adhesive tape or sheet, the laminated tape or sheet has a structure in which the first separator, the first adhesive agent layer, the support, the second adhesive agent layer are laminated in this order. In this case, by having the first separator, the first adhesive agent layer and the second adhesive agent layer on the outermost layer of laminate are each protected by the first separator when being wound in a roll shape in the longitudinal direction, and thus the laminate blocking is prevented.

When the separator is formed only on the outer side of the adhesive agent layer on one side of the double-sided adhesive tape or sheet, the separator is prevented from peeling off unexpectedly when drawn out from the wound state, and the like, so it is preferable that peeling forces (that is, a peeling force between the first adhesive agent layer and the first separator, and a peeling force between the second adhesive agent layer and the second separator) on the both surfaces of the first separator are not the same. It is preferable that when the laminated structure of the separator is a structure of two or more layers in which the base material and the release layer are formed in order, the peeling forces on the both surfaces can be easily made different. In addition, when it is difficult to make the peeling force of the both surfaces different from each other such as when those having a single-layer structure made of only the base material are used as the first separator, the adhesive forces of the first adhesive agent layer and the second adhesive agent layer may be different.

In the laminated tape or sheet, when the separator is formed only on the outer sides of each of the adhesive agent layers on the both surfaces of the double-sided adhesive tape or sheet, the laminated tape or sheet has a structure in which the first separator, the first adhesive agent layer, the support, the second adhesive agent layer, and the second separator are laminated in this order. In this case, the first adhesive agent layer and the second adhesive agent layer on the outermost layer of the laminate are each protected by the first separator and the second separator, so the laminate blocking is prevented when the first adhesive agent layer and the second adhesive agent layer are in the state wound in the roll shape in the longitudinal direction. Moreover, the first adhesive agent layer and the second adhesive agent layer can be used in various shapes such as a strip shape and a flat plate shape.

When the separator is formed on the outer sides of each of the adhesive agent layers of the both surfaces of the double-sided adhesive tape or sheet, since it is easy to peel off the separators sequentially from the double-sided adhesive tape or sheet, it is preferable that the peeling force of the first separator and the peeling forces of the second separator (a peeling force between the first separator and the first adhesive agent layer and a peeling force between the second separator and the second adhesive agent layer) are not the same. Alternatively, the adhesive forces of the first adhesive agent layer and the second adhesive agent layer may be different.

3. Production Method of Double-Sided Adhesive Tape or Sheet

The production method of the double-sided adhesive tape or sheet is a production method including, for example, a step of forming the support with the above-described polypropylene resin composition, and a step of forming the adhesive agent layer with the above-described acrylic adhesive composition, thereby producing the double-sided adhesive tape or sheet.

In the obtained double-sided adhesive tape or sheet, the total thickness (Ds) of the laminate is 4 to 15 μm, and the value of the ratio Dp/Ds of the thickness (Dp) of the support and the total thickness (Ds) of the laminate is 0.15 to 0.6.

The step of forming the support with the polypropylene resin composition can have the same configuration as the “support formation step” described above.

In addition, the polypropylene resin composition forming the support preferably contains 80 to 100% by mass of isotactic homopolypropylene having a mesopentad fraction of 90 to 99.5% with respect to the total amount of the polypropylene resin composition. In this case, since the strength of the obtained double-sided adhesive tape or sheet can be improved, and furthermore, the insulating properties can be improved, it is easy to produce the double-sided adhesive tape or sheet which is excellent in durability.

The polypropylene resin contained in the polypropylene resin composition preferably has a melting point of 155 to 175° C. In this case, the melting point of the support formed can be increased, and the insulating properties of the double-sided adhesive tape or sheet at a high temperature can be improved. Note that the melting point of the polypropylene resin is 155 to 175° C., which is the same definition as described above.

The polypropylene resin contained in the polypropylene resin composition preferably has a melt mass flow rate (MFR) of 2 to 7 g/10 min. The support formed of such isotactic homopolypropylene has excellent uniformity (thickness deviation) in thickness of the film or sheet, so it is easy to adjust the thickness of each layer of the double-sided adhesive tape or sheet and the quality stability is excellent Herein, the melt mass flow rate (MFR) is a value measured under the same measurement conditions as described above.

The step of forming the adhesive agent layer using the acrylic adhesive composition is the same as the above-described “step of forming adhesive agent layer”.

The adhesive agent layer may be formed, for example, by applying the acrylic adhesive composition to the both surfaces of the support. Thereby, the laminate can be obtained.

Alternatively, the adhesive agent layer may be formed on the separator. After forming the adhesive agent layer on the separator, the surface of the side of the adhesive agent layer of the separator is bonded to the support. Thereby, the laminated tape or sheet is obtained, and the separator is peeled off from the obtained laminated tape or sheet to obtain the double-sided adhesive tape or sheet.

An example of the production method of a double-sided adhesive tape or sheet includes a production method including a step of forming the adhesive agent layer on the separator and a step of bonding the surface of the side where the adhesive agent layer of the separator is formed to the one side or both surfaces of the support. In detail, two separators (referred to as the first separator and the second separator, respectively) in which the adhesive agent layer is formed as described above are prepared, and the first separator is bonded to one side of the support, and the second separator is bonded to the other side of the support. By bonding the surfaces of each separator on the sides of the adhesive agent layers to the support, the laminated tape or sheet having the separators on the both surfaces can be obtained. Note that the second separator is not necessarily prepared, and only the first separator may be bonded to one side of the support.

Thereafter, the double-sided adhesive tape or sheet is obtained by a step of peeling off the separators on the both surfaces or one side from the laminated tape or sheet. The obtained double-sided adhesive tape or sheet includes the laminate including the support and two adhesive agent layers formed on the both surfaces of the support.

According to the above production method, the double-sided adhesive tape or sheet can be produced by a simple method.

The separator used here has the same configuration as described above. The amount of the acrylic adhesive composition applied to the separator may be applied so as to be formed with the thickness (for example, 1 to 6 μm) of the above-described adhesive agent layer after the drying. As the application method, for example, the method described in the step of forming the adhesive agent layer can be used.

The support contains the polypropylene resin, and the total thickness (Ds) of the laminate and the ratio (Dp/Ds) of the thickness of the support and the total thickness are in a specific range, so the double-sided adhesive tape or sheet of the present invention produced as described above is excellent in the strength, adhesiveness and insulating properties even if the double-sided adhesive tape or sheet is light-weight and the thickness of the double-sided adhesive tape or sheet is thin. In particular, since the support contains the polypropylene resin, the double-sided adhesive tape or sheet is light-weight even at the same thickness as the known double-sided adhesive tape or sheet, which contributes to weight reduction of electronic components used, and the like. In addition, the polypropylene resin is excellent in chemical resistance, and even when the polypropylene resin is used as a constituent member of a secondary battery or the like, the deterioration and damage due to an electrolyte and the like that are contained in the secondary battery are less likely to occur. In addition, the double-sided adhesive tape or sheet of the present invention is excellent in strength and insulating properties even if the thickness of the double-sided adhesive tape or sheet is thin, and therefore is particularly suitable for electronic components, optical components, and the like in addition to various types of batteries represented by small secondary batteries. Specifically, as the use of the double-sided adhesive tape or sheet of the present invention, for example, in a battery in which an electrolytic solution such as a lithium ion battery is enclosed, the double-sided adhesive tape or sheet is used for the purpose of improving packaging suitability of electrodes in a battery case and for the purpose of preventing a short circuit between electrodes caused by burrs or the like, which are present in a polar plate, passing through the separator.

In the laminated tape or sheet of the present invention, the blocking of the double-sided adhesive tape or sheet having the above-described excellent effects is protected. Further, the laminated tape or sheet of the present invention can efficiently use the double-sided adhesive tape or sheet by peeling off the separator.

### EXAMPLE

Hereinafter, the present invention will be more specifically described with reference to Examples, but the present invention is not limited to the Examples.

### Example 1

An isotactic homopolypropylene resin manufactured by Prime Polymer Co., Ltd., which has an MFR of 4.9 g/10 min, a melting point of 164° C., and a mesopentad fraction of 97%, is supplied to a single screw extruder and is melted at 240° C. Thereafter, the melted resin was filtered through a sintered metal nonwoven fabric filter having a filtration accuracy of 10 μm and extruded using a T die. Next, the extruded resin was cooled and solidified by a metal drum maintained at a surface temperature of 90° C. to produce a raw fabric sheet having a thickness of about 120 μm. This raw fabric sheet is stretched 5 times in a flow direction between two heating rolls (temperature of 142° C.) with a peripheral speed difference, heated in an oven of 158° C. with a tenter, stretched 10 times in a transverse direction, and then relaxed up to 9.5 times. A biaxially oriented polypropylene film having a thickness of 3.5 μm was obtained as a support. A density of the support was 0.918 g/cm³. Both surfaces of the support were subject to corona treatment so that a wet tension (JIS K-6768 (1999)) of the surface was 40 mN/m.

The crosslinkable acrylic copolymer (A) was prepared by solution polymerization in ethyl acetate. A reaction vessel equipped with a stirrer, a nitrogen gas introduction tube, a thermometer, and a reflux condenser, into which a noncrosslinkable (meth)acrylic ester monomer (noncrosslinkable (meth)acrylic ester unit (a1)) composed of 80 parts by mass of n-butyl acrylate and 17 parts by mass of methyl acrylate, an acrylic monomer (crosslinkable acrylic monomer unit ((a2)) having a crosslinkable functional group composed of 3 parts by mass of acrylic acid, 150 parts by mass of ethyl acetate (EtAc), and 20 parts by mass of methyl ethyl ketone (MEK) were introduced was heated to 70° C. with the introduction of nitrogen gas. Next, 0.05 parts by mass of polymerization initiator azobisisobutyronitrile (AIBN) was added, and a polymerization reaction was performed at 70° C. for 8 hours in a nitrogen atmosphere. After the polymerization reaction was completed, those polyermized were diluted with ethyl acetate (EtAc) so that a solid content concentration was 25%, thereby obtaining a crosslinkable acrylic copolymer (A)-containing composition.

100 parts by mass of the above crosslinkable acrylic copolymer (A) was mixed with 0.02 parts by mass of an epoxy-based crosslinking agent N,N,N′,N′-tetraglycidyl-m-xylenediamine (Mitsubishi Gas Chemical Co., Inc.: TETRAD (registered trademark)X) as the crosslinking agent (B), diluted with ethyl acetate to be a solution whose solid content concentration is 20%, and stirred, thereby preparing an acrylic adhesive composition.

The acrylic adhesive composition was coated on a release agent-treated surface of a first transparent separator (manufactured by Teijin DuPont Films Co., Ltd., biaxially stretched polyethylene terephthalate film treated with silicone-based release agent, thickness 50 μm) using a doctor blade YD type manufactured by Yoshimitsu Seiki Co., Ltd., so that the thickness after drying was 4 μm. Thereafter, the acrylic adhesive composition was dried at 100° C. for 3 minutes by a hot air dryer to remove the solvent in the acrylic adhesive composition, thereby forming the adhesive agent layer. Note that the acrylic copolymer in the adhesive agent layer was crosslinked. Next, the support was laminated on the formed adhesive agent layer and pressure-bonded by a roller.

The acrylic adhesive composition was coated on a release agent-treated surface of a second transparent separator (manufactured by Teijin DuPont Films Co., Ltd., biaxially stretched polyethylene terephthalate film treated with silicone-based release agent heavier than the first separator, thickness 37 μm) using the doctor blade YD type manufactured by Yoshimitsu Seiki Co., Ltd., so that the thickness after drying was 3 μm. Thereafter, the acrylic adhesive composition was dried at 100° C. for 3 minutes by a hot air dryer to remove the solvent in the acrylic adhesive composition, thereby forming the adhesive agent layer. Note that the acrylic copolymer in the adhesive agent layer was crosslinked. Next, a support side of a laminated product in which the above-described “first separator, adhesive agent layer, support” are laminated in order was laminated on the formed adhesive agent layer, and the laminated sheet was obtained by being pressure-bonded by a roller.

The laminated sheet is formed (configured) by laminating a first separator, a first adhesive agent layer, the support, a second adhesive agent layer, and a second separator in this order. Further, the laminate (that is, double-sided adhesive sheet) is formed (configured) by the first adhesive agent layer, the support, and the second adhesive agent layer.

### Examples 2 to 5. Comparative Examples 1 and 2

As shown in Table 1, a laminated sheet was obtained in the same manner as in Example 1, except that one or more conditions of a thickness of a support and a thickness of an adhesive agent layer in Example 1 were changed.

### Example 6

A laminated sheet was obtained in the same manner as in Example 1 except that an isotactic homopolypropylene resin manufactured by Prime Polymer Co., Ltd. with an MFR of 3.1 g/10 min, a melting point of 159° C., and a mesopentad fraction of 92% was used as a polypropylene resin. Note that a density of the formed support was 0.909 g/cm³.

### Comparative Example 3

A laminated sheet was obtained in the same manner as in Example 1 except that a commercially available biaxially stretched polyethylene terephthalate film (Lumirror (registered trademark) F53 manufactured by Toray Industries, Inc., thickness 3.5 μm, density 1.44 g/cm³) was used as support.

TABLE 1

| | Thickness | | | | | |
|---|---|---|---|---|---|---|
| | Support | Adhesive | Adhesive | Total | | Density of |
| | Dp | layer 1 | layer 2 | thickness Ds | Dp/Ds | laminate |
| | μm | μm | μm | μm | μm | g/cm³ |
| Example 1 | 3.5 | 4 | 3 | 10.5 | 0.333 | 1.01 |
| Example 2 | 2.5 | 4 | 3 | 9.5 | 0.263 | 1.02 |
| Example 3 | 2.5 | 5.5 | 5.5 | 13.5 | 0.185 | 1.03 |
| Example 4 | 2.0 | 2 | 2 | 6 | 0.333 | 1.01 |
| Example 5 | 5.0 | 1.8 | 1.8 | 8.6 | 0.581 | 0.98 |
| Example 6 | 3.5 | 4 | 3 | 10.5 | 0.333 | 1.00 |
| Comparative | 2.0 | 0.5 | 0.5 | 3 | 0.667 | 0.96 |
| Example 1 | | | | | | |
| Comparative | 2.0 | 7 | 7 | 16 | 0.125 | 1.12 |
| Example 2 | | | | | | |
| Comparative | 3.5 | 4 | 3 | 10.5 | 0.333 | 1.20 |
| Example 3 | | | | | | |

| | | | Dielectric | Adhesiveness | | | |
|---|---|---|---|---|---|---|---|
| | Rupture stress | | breakdown | Adhesive layer 1 | | Adhesive layer 2 | |
| | Flow | Width | voltage | N/25 | | 25 | |
| | MPa | MPa | kV | mm | Evaluation | mm | Evaluation |
| Example 1 | 57 | 97 | 2.6 | 2.5 | ⊙ | 2.3 | ⊙ |
| Example 2 | 46 | 77 | 2.3 | 2.5 | ⊙ | 2.3 | ⊙ |
| Example 3 | 32 | 55 | 3.0 | 2.8 | ⊙ | 2.8 | ⊙ |
| Example 4 | 58 | 97 | 1.4 | 2.1 | ⊙ | 2.1 | ⊙ |
| Example 5 | 99 | 169 | 2.4 | 1.8 | ◯ | 1.8 | ◯ |
| Example 6 | 44 | 81 | 2.2 | 2.5 | ⊙ | 2.3 | ⊙ |
| Comparative | 114 | 194 | 0.9 | 0.9 | Δ | 0.9 | Δ |
| Example 1 | | | | | | | |
| Comparative | 22 | 37 | 3.3 | 3.2 | ⊙ | 3.2 | ⊙ |
| Example 2 | | | | | | | |
| Comparative | 122 | 75 | 2.2 | 2.4 | ⊙ | 2.2 | ⊙ |
| Example 3 | | | | | | | |

Table 1 shows a thickness (Dp) of a support, a thickness of a first adhesive agent layer, a thickness of a second adhesive agent layer, a total thickness (Ds) of a laminate, a ratio (Dp/Ds) of the thickness of the support and the total thickness of the laminate, a rupture stress (in a flow direction and a width direction) of the laminate, a dielectric breakdown voltage of the laminate, adhesiveness (first adhesive agent layer side and second adhesive agent layer side) of the laminate.

From the comparison of Examples 1 to 6 and Comparative Examples 1 to 3, the double-sided adhesive sheet in which the total thickness Ds of the laminate is 4 to 15 μm and the value of the Dp/Ds is 0.15 to 0.6 is excellent in density, strength, insulating properties, and adhesiveness.

On the other hand, in Comparative Example 1, since the value of the total thickness Ds is small, and the ratio of the thickness of the support to the total thickness of the laminate is too large, the adhesiveness was inferior, and thus the adherend cannot be sufficiently fixed and furthermore, the insulating properties were also lowered. In Comparative Example 2, since the value of the total thickness Ds was large, and the ratio of the thickness of the support to the total thickness of the laminate was too small, the rupture stress was small, so the handling ability such as bonding was inferior. In addition, the double-sided adhesive sheet was thick and heavy without satisfying the required thickness and density.

In Comparative Example 3, since the support was a polyethylene terephthalate film, it was heavy without satisfying the required density. In comparison between Example 1 and Comparative Example 3 having the same thickness configuration, Example 1 is lighter, has a higher dielectric breakdown voltage, and has an appropriate strength and therefore has good irregularities followability, so it is possible to show better member fixing performance and insulating properties in the limited volume/weight requirements of small electronic components and the like.

In addition, the double-sided adhesive sheets of Examples 1 and 2 could be bonded to a stainless steel test plate to follow a nano-order level of irregularities of the stainless steel test plate without forming voids on the stainless steel test plate, when bonded to the stainless steel test plate that is the adherend. On the other hand, the double-sided adhesive sheet of Comparative Example 3 could not be bonded so as to follow the minute irregularities. That is, the double-sided adhesive sheets of Examples 1 and 2 were excellent in the irregularities followability than the double-sided adhesive sheet of Comparative Example 3.

<Evaluation Method>

[Melting Mass Flow Rate of Resin (MFR)]

According to JIS K-7210 (1999), the measurement was performed under the conditions of a measurement temperature of 230° C. and a load of 21.18 N using a melt indexer manufactured by Toyo Seiki Seisaku-sho, Ltd. The unit of the MFR in this evaluation is g/10 minutes.

[Melting Point of Resin]

The calculation was performed according to the following procedure using an input compensation type DSC and Diamond DSC manufactured by Perkin Elmer, Inc. 5 mg of resin for measurement (resin as a raw material) was weighed, packed in a sample holder made of aluminum, and set in a DSC apparatus. The temperature was raised from 30° C. to 280° C. at a rate of 20° C./min under a nitrogen flow, kept at 280° C. for 5 minutes, cooled to 30° C. at a rate of 20° C./min, and kept at 30° C. for 5 minutes. Thereafter, the melting point was determined from the DSC curve when the temperature was raised again to 280° C. at a rate of 20° C./min. A melting peak (maximum melting peak when a plurality of melting peaks are shown) defined in 9.1 (1) of JIS-K7121 was measured to obtain the melting point.

[Thickness]

The total thickness of the laminated sheets (five-layer structure of the first separator, the first adhesive agent layer, the support, the second adhesive agent layer, and the second separator) was measured according to JIS-C2330 using a tabletop contact type thickness gauge TOF-5R01 manufactured by Yamabun Electronics Co., Ltd.

In addition, the thicknesses of the support, the adhesive agent layer, and the separator were calculated using the total thickness of the laminated sheet and the ratio of each layer to total thickness of the laminated sheet. This ratio was obtained by measuring an image obtained by observing a test piece for cross-sectional observation, which is obtained by cutting the laminated sheet with a microtome (UC6 by Leica Microsystems Co., Ltd.), with a microscope.

Note that from the relationship between the respective thicknesses, the ratio between the first separator and the laminate and the second separator was first obtained, and the total thickness Ds of the laminate was calculated. Subsequently, the observation magnification of the microscope was increased, the ratio of the first adhesive agent layer and the support and the second adhesive agent layer was determined, and the respective thicknesses were calculated.

[Density]

The density was measured according to JIS K-7112 (1999) D method and converted to unit g/cm³.

[Rupture Stress]

In accordance with JIS K-7127 (1999), the stress at the time of rupture in a width direction and a flow direction was measured under the conditions of 23° C., a test speed of 200 mm/min, and an inter-chuck distance of 100 mm by using one (sample width 15 mm and sample length 160 mm) having a sample shape conforming to test piece type 2 and using a tensile tester (Universe tensile tester Technograph TGI-1kN manufactured by Minebea Co., Ltd.). The measurement was performed using a test piece which is cut out in a length of 160 mm in a flow direction and a width of 15 mm in a width direction when measuring a tensile modulus of elasticity and an elongation in the flow direction and a test piece which is cut out in a length of 160 mm in a width direction and a width of 15 mm in a flow direction when measuring a tensile modulus of elasticity and an elongation in the width direction.

Note that the test piece was cut out in the state of the laminated sheet (five-layer structure of the first separator, the first adhesive agent layer, the support, the second adhesive agent layer, and the second separator). In addition, the measurement was performed by peeling off the first separator and the second separator and using the laminate (the first adhesive agent layer, the support, and the second adhesive agent layer).

[Dielectric Breakdown Voltage]

The first separator was peeled off from the laminated sheets (5-layer structure of the first separator, the first adhesive agent layer, the support, the second adhesive agent layer, and the second separator) obtained in Examples and Comparative Examples, and the first adhesive agent layer appearing on the surface is stuck to an aluminum foil which is a lower electrode. Furthermore, the second separator is peeled off, an upper electrode is disposed on the surface of the second adhesive agent layer that appears on another surface, and a dielectric breakdown voltage value was measured 12 times at 100° C. using a DC power source according to JIS C2330 (2001) 7.4.11.2 B Method (plate electrode method). For the measurement, a DC withstand voltage/insulation resistance tester TOS9213AS manufactured by Kikusui Electronics Corporation was used. The average value of 8 times excluding the upper 2 times and the lower 2 times from the measurement results of 12 times was taken as the dielectric breakdown voltage (kV).

[Adhesive Force (Adhesiveness)]

The adhesive force was measured in accordance with JIS Z-0237 (2009) Method 3 (test method for peeling off a double-sided adhesive tape at 180° for a stainless steel test plate), converted to a value of 25 mm width, and determined by the following criteria.

⊙: The adhesive force was measurable, and the adhesive force was 2 N/25 mm or more (available).

∘: The adhesive force was measurable, and the adhesive force was 1 N/25 mm or more and less than 2 N/25 mm (available).

Δ: The adhesive force was measurable, and the adhesive force was less than 1 N/25 mm (difficult to use).

x: The laminate did not stuck to a stainless steel test plate or was peeled off easily and therefore the adhesive force could not be measured (unavailable).

### DESCRIPTION OF REFERENCE SIGNS

1: Double-sided adhesive tape or sheet
10: Laminate
11: Support
12: Adhesive agent layer
12a: First adhesive agent layer
12b: Second adhesive agent layer
13: Separator
2: Laminated tape or sheet
Ds: Total thickness of laminate
Dp: Thickness of support

1. A double-sided adhesive tape or sheet comprising: a laminate including a support and two adhesive agent layers formed on both surfaces of the support,
wherein the support contains a polypropylene resin,
the adhesive agent layer contains an acrylic polymer;
wherein a total thickness (Ds) of the laminate is 4 to 15 μm,
a ratio Dp/Ds of a thickness (Dp) of the support to the total thickness (Ds) of the laminate is 0.15 to 0.6, and
a density of the laminate is 0.90 to 1.10 g/cm³.

2. The double-sided adhesive tape or sheet according to claim 1, wherein a value of the ratio Dp/Ds is 0.18 to 0.35, and the density of the laminate is 0.90 to 1.07 g/cm³.

3. The double-sided adhesive tape or sheet according to claim 1, wherein the thickness (Dp) of the support is 1.5 to 6 μm.

4. The double-sided adhesive tape or sheet according to claim 1, wherein the support is a biaxially oriented polypropylene film having a density of 0.90 to 0.94 g/cm³.

5. The double-sided adhesive tape or sheet according to claim 1, wherein the support contains 80 to 100% by mass of isotactic homopolypropylene having a mesopentad fraction of 90 to 99.5% with respect to a total mass of the support.

6. The double-sided adhesive tape or sheet according to claim 1, wherein the adhesive agent layer contains as a main component an acrylic copolymer containing a noncrosslinkable (meth)acrylic ester unit (a1).

7. The double-sided adhesive tape or sheet according to claim 1, wherein the adhesive agent layer is a layer in which an acrylic adhesive composition is solidified, and the acrylic adhesive composition contains as a main component a crosslinkable acrylic copolymer (A) containing a noncrosslinkable(meth)acrylic ester unit (a1) and a crosslinkable acrylic monomer unit (a2) having a crosslinkable functional group.

8. The double-sided adhesive tape or sheet according to claim 7, wherein the noncrosslinkable(meth)acrylic ester unit (a1) is two types of an n-butyl acrylate monomer unit and a methyl acrylate monomer unit, the crosslinkable acrylic monomer unit (a2) having the crosslinkable functional group is an acrylic acid monomer unit, and in the crosslinkable acrylic copolymer (A), the n-butyl acrylate monomer unit is 45 to 84% by mass, the methyl acrylate monomer unit is 15 to 54% by mass, and the acrylic acid monomer unit is 1 to 10% by mass.

9. The double-sided adhesive tape or sheet according to claim 1, wherein the adhesive agent layer is a layer in which an acrylic adhesive composition is solidified, and the acrylic adhesive composition contains a crosslinking agent (B).

10. The double-sided adhesive tape or sheet according to claim 9, wherein the crosslinking agent (B) is at least one selected from the group consisting of N,N,N′,N′-tetraglycidyl-m-xylenediamine and 1,3-bis(N,N-diglycidylaminomethyl)cyclohexane.

11. A laminated tape or sheet comprising:
the double-sided adhesive tape or sheet according to claim 1; and
a separator,
wherein the separator is formed on an outer side of the adhesive agent layer on at least one side of the double-sided adhesive tape or sheet.

12. The laminated tape or sheet according to claim 11, wherein the separator is formed on the outer sides of each of the adhesive agent layers on both sides.
